(19) United States
(12) Patent Application Publication
(10) Pub. No.: US 2024/0108542 A1
(43) Pub. Date: Apr. 4, 2024

(54) Mechanical CPR Device with Flex Correction

(71) Applicant: Defibtech, LLC, Guilford, CT (US)

(72) Inventor: Patrick Perdu, Guilford, CT (US)

(21) Appl. No.: 18/459,829

(22) Filed: Sep. 1, 2023

Related U.S. Application Data
(60) Provisional application No. 63/378,284, filed on Oct. 4, 2022.

(51) Int. Cl. A61H 31/00

(52) U.S. Cl. CPC A61H 31/006; A61H 2201/0165; A61H 2201/0196; A61H 2201/5007

(57) ABSTRACT

The invention provides, in some aspects, an AMCPR method and apparatus that apply a continuous flex correction where a flex correction is determined based on one or more strokes, and applied to a subsequent compressive stroke. In these aspects, for example, the AMCPR's control system determines the flex correction to a future compressive stroke based on the rail voltage and amperage applied to a motor during a prior compressive stroke, such as an immediately prior stroke or such as the penultimate stroke. As a result of using the rail voltage and amperage applied to the motor, the need for an additional sensor means, such as a force sensor, has been removed.

This application claims the benefit of priority of U.S. Patent Application Ser. No. 63/378,284, entitled Mechanical CPR Device with Flex Correction, filed Oct. 4, 2022, the teachings of which are incorporated herein by reference.

### TECHNICAL FIELD

The invention relates to kinesitherapy and more specifically to providing cardiopulmonary resuscitation (CPR).

### BACKGROUND OF THE INVENTION

Cardiopulmonary Resuscitation (CPR) is a well-known, first-aid treatment ideally performed on a patient suffering cardiac arrest. CPR is an external heart massage technique that manually preserves blood circulation through a patient's body in an attempt to maintain the body's organs, primarily the brain, until a normal heart rhythm, or blood flow, can be restored.

Performing manual CPR (i.e., CPR compressions given by a person) is strenuous, even using devices that provide a mechanical advantage. Proper CPR requires about 100, 5-cm-deep compressions of the chest per minute, each compression potentially requiring a force upwards of 550 N. Therefore, maintaining high-quality, manual CPR for an extended period, even more than several minutes, can be exhausting. Additionally, a CPR provider must maintain proximity to the patient. Maintaining proximity can be challenging to impossible when the patient on whom the CPR is being performed is being moved, whether being carried on a backboard (e.g., through doorways, down halls or on stairs) or being transported in a vehicle.

Autonomous mechanical CPR (AMCPR) devices, which are well known in the art, can overcome many of the issues associated with providing manual CPR. These AMCPR devices can be associated with a patient and once started do not require human intervention, or even necessitate human proximity, and will continue CPR as long as their power source permits.

AMCPRs generally comprise an upper portion, sometimes referred to as a support assembly that includes a compression unit (i.e., a device having a control system, power source, and extendable ram) for compressing a patient's chest. The support assembly engages a lower portion, sometimes referred to as a backboard. The support assembly and backboard thereby defining a space into which a patient's torso may be positioned. Support assemblies are usually self-supporting, but that need not be the case. Additionally, the space may fully surround the patient's chest or partially surround it.

The compression unit is fixed, permanently or temporarily, in the support assembly in such a manner as to interact with a patient's chest. Where the compression unit has an extendable, reciprocating ram, the ram is ideally positioned with a line of applied compressive force perpendicular to the chest.

The American Heart Association (AHA) recommends cardiopulmonary resuscitation (CPR) compress a patient's chest between 2.0″ and 2.4″. Published data indicates that the depth versus force applied for human chests can vary widely. In some cases, the force needed to reach a compressive depth increases only slightly with depth, but in some cases the increase in force needed to compress a chest can be significant. For example, generally the force needed to begin compressing a chest is between 1 to 10 N reaching 4 to 20 N at a depth of 50 mm. However, some chests need in excess of 40 N to reach this depth.

Wide variations in compressive force present design issues for AMCPRs. AMCPRs are intended for use by first responders; thus, they must be portable. As a result, minimizing weight is a key design parameter. Problematically, reductions in weight in AMCPR devices results in support assemblies that may have significant flex while performing CPR. Wide variations in potential compressive forces can introduce significant flex variation. As a result, unless flex variation is accounted for, the CPR delivered may fail to be within identified guidelines.

Currently, AMCPRs utilize force sensing means for flex correction; however, this is problematic and unduly adds cost and complexity to the system.

What is needed are improved AMCPRs. What is also need are AMCPRs that are less costly to manufacture and maintain, and are more accurate and rugged.

### SUMMARY OF THE INVENTION

The foregoing objects are among those attained by the invention, which provides, in some aspects, an AMCPR method and apparatus that apply a continuous flex correction where a flex correction is determined based on one or more prior strokes, and where that flex correction is applied to one or more subsequent compressive strokes. In these aspects, for example, the AMCPR's control system can determine the flex correction to a future compressive stroke based on the rail voltage and amperage applied to a motor during the one or more prior compressive strokes, such as an immediately prior stroke or such as the penultimate stroke. As a result of using the rail voltage and amperage applied to the motor, the need for an additional sensor means, such as a force sensor, has been removed.

In other aspects of the invention there is provided an AMCPR method and apparatus, e.g., as described above, wherein the flex correction magnitude may include a filtering system to dampen the delta between flex corrections applied to subsequent compressions.

In still other aspects, the invention provides a mechanical CPR device having a support assembly with a compression system mounted therein, the support assembly defining a volume sufficient in size to accommodate a patient's torso. The compression system includes a motor coupled to a drivetrain having a patient interface, and the compression system is positioned within the support assembly to permit reciprocation of the drivetrain to deliver a compressive stroke of CPR to the patient. A control system is coupled to the motor to reciprocate the drivetrain so that the patient interface interacts with the patient's torso to deliver the compressive stroke of CPR to a therapeutic depth. The control system is coupled to the motor by way of at least one first sensor to obtain rotational information and by way of at least one second sensor to obtain applied amperage and applied voltage. The control system converts (i) the obtained rotational information into a displacement of the patient interface, and (ii) the applied amperage and applied voltage obtained into a flex correction, which it applies to the therapeutic depth in a subsequent compressive stroke.

Related aspects of the invention provide a device, e.g., as described above, in which the control system determines a therapeutic depth for the reciprocating patient interface, delivers a compressive stroke based on the therapeutic depth, determines for the delivered compressive stroke the flex correction based on the applied amperage and applied voltage obtained; and sets the depth of a subsequent compressive stroke to the therapeutic depth plus the determined flex correction.

Further related aspects of the invention provide a device, e.g., as described above, in which the control system applies a continuous flex correction determined based on one or more prior strokes and where that flex correction is applied to a subsequent compressive stroke.

Yet still further related aspects of the invention provide a device, e.g., as described above, wherein the control system determines the flex correction based on the rail voltage and amperage applied to a motor during one or more prior compressive strokes, such as an immediately prior stroke or such as a penultimate stroke.

Still yet further aspects of the invention, provide a device, e.g., as described above, in which the flex correction magnitude is determined using a filtering system to dampen a delta between flex corrections applied to subsequent compressions.

In other aspects, the invention provides a method for flex correction of a compressive stroke based on a previous compressive stroke in a mechanical CPR device comprising the steps of: obtaining a mechanical CPR device having a support system with a compression system coupled to drive system mounted thereon, the compression system having a motor and patient interface, the motor capable of reciprocating a patient interface into a patient's chest to provide a CPR compressive stroke; defining for the mechanical CPR system a first force relationship based on applied current and voltage to the motor; categorizing the flex of the support assembly based on a second applied force to obtain a second force relationship; determining a therapeutic depth for the reciprocating patient interface; delivering a compressive stroke based on the therapeutic depth; determining for the delivered compressive stroke a flex correction based on the first and second force relationship; and setting the depth of a subsequent compressive stroke to the therapeutic depth plus the determined flex correction.

These and other aspects and advantages of the invention will become apparent from the following detailed description and the accompanying drawings that illustrate by way of example the features of the invention.

### BRIEF DESCRIPTION OF THE DRAWINGS

A more complete understanding of the invention may be attained by reference to the drawings, in which:

FIG. 1 is a front view of an illustrative CPR Device in an initial position.

FIG. 2 is a front view of an illustrative CPR Device in a first operational position.

FIG. 3 is a front view of an illustrative CPR Device in a third operational position showing the flex induced in the structure (the original position is shown by the dotted lines).

FIG. 4 shows the components of a compressive stroke.

FIG. 5 is a map of a compressive stroke.

FIG. 6 is a bilinear interpolation of the applied force, motor current, and power rail voltage.

FIG. 7 is a linear interpolation of force versus flex.

FIG. 8 is a flowchart for determining a flex correction.

FIG. 9 is a Random walk filter.

### DETAILED DESCRIPTION OF THE ILLUSTRATED EMBODIMENT

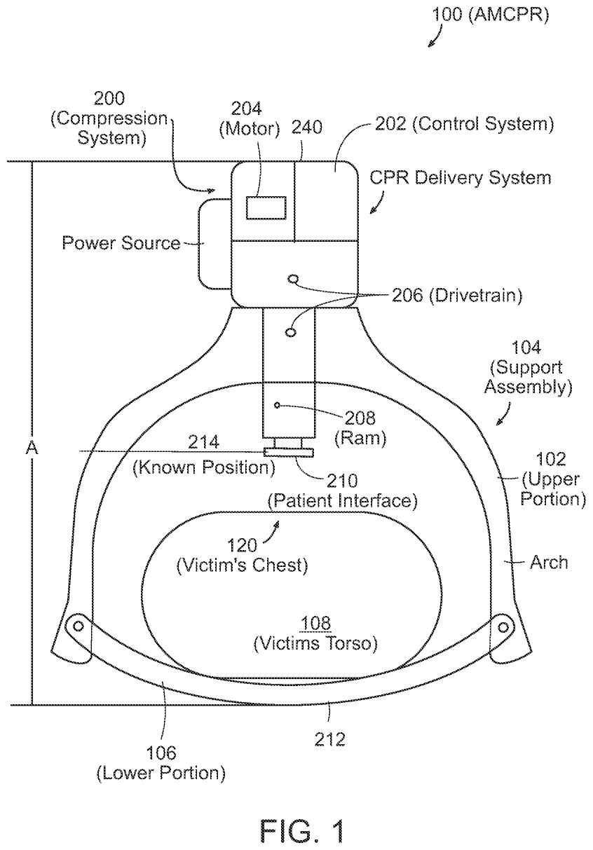

As shown in FIG. 1, an AMCPR, generally referred to by reference number 100, includes an upper portion 102, having a support assembly 104, illustrated in the form of an arch, which is releasably connected to a lower portion 106, sometimes referred to as a backboard. Mounted to the support assembly is a compression system 200. The resting height of the AMCPR is “A,” which is measured from a lower surface 212 of the lower portion 106 to an upper surface 240 of the compression system along the line of applied compressive force of the compression system (discussed below), but other vector references could be used.

The illustrated support assembly 104 is self-supporting, but this is not a requirement of the invention. Also, the illustrated support assembly is shown as defining an enclosed space, this too is not a requirement of the invention.

The compression system 200 includes a control system 202, a motor 204, and a ram 208. In use, a patient's torso 108, shown in cross-section, is placed between the upper portion 104 and the lower portion 106 such that the compression system 200, more specifically the patient interface 210 connected to the ram, provides an applied line of compressive force that generally interacts perpendicularly with the patient's chest 120.

The drivetrain (not shown), which could be a ball screw, drives a ram 208 that reciprocates by changing the motor's 204 rotational direction. Illustrated control system 202 contains a micro-processor with suitable components, such as memory, to retain and execute programming to carry out the functions ascribed herein to that control system. The programming needed to accomplish those functions is within the ken of those skilled in the art in view of the teachings hereof.

The control system 202 of the illustrated embodiment is coupled (e.g., electrically connected) to the motor 204 by way of at least a first sensor to obtain applied amperage and applied rail voltage from which force can be calculated, as discussed below. In some embodiments, it can additionally be coupled to the motor by way of at least a second sensor to obtain rotational information from which patient interface 210 and chest displacement (or compression depth) can be determined, as is within the ken of those skilled in the art in view of the teachings hereof.

The motor and control system 202 are powered by a power source 208, which can be a battery. The motor is mechanically coupled to the drivetrain, with the motor being controlled by the control system. The motor directed by the control system using the drivetrain moves a patient interface 210, mounted on the distal end of the ram, toward, into, and away from the patient's chest 120. The illustrative patient interface is a contract type patient interface (i.e., it is not temporarily adhered to the chest). Adhered patient interfaces, such as suction cups, adhesives, could also be used.

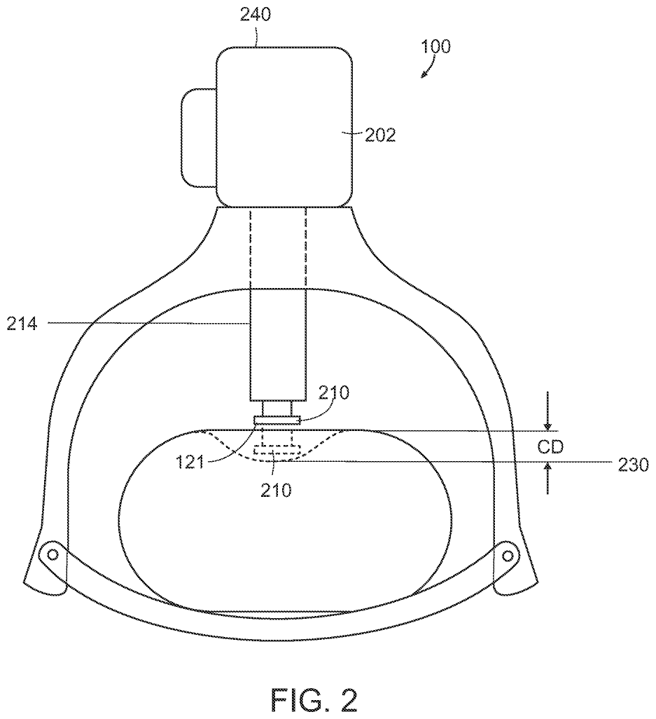

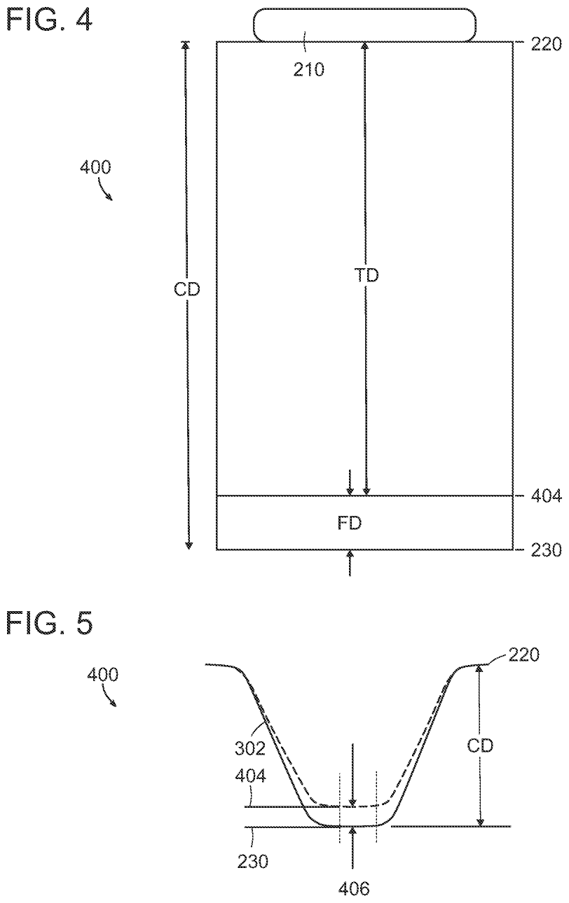

Continuing with FIG. 2, the control system 202, using its onboard computer system, having programming running thereon, when activated forces the movement of the patient interface 210 into the patient's chest 120 thereby beginning a chest compression. The chest compression is completed when the patient interface is withdrawn from the patient's chest allowing, or forcing, the patient's chest back to a zenith position for a next compressive stroke. The chest compression begins at a starting position 220, a position that ideally places the patient interface 210 in contact with the chest with the skin thereon slightly compressed, moving to an extended position 230. The Compression Depth “CD” is defined as the distance between the starting position and the extended position defining a zenith and nadir of a compression stroke 302 (see FIG. 4). It is understood that depending upon the specific programming characteristics of the AMCPR 100, CD may vary across strokes, from factors such as anatomic changes in a patient's chest.

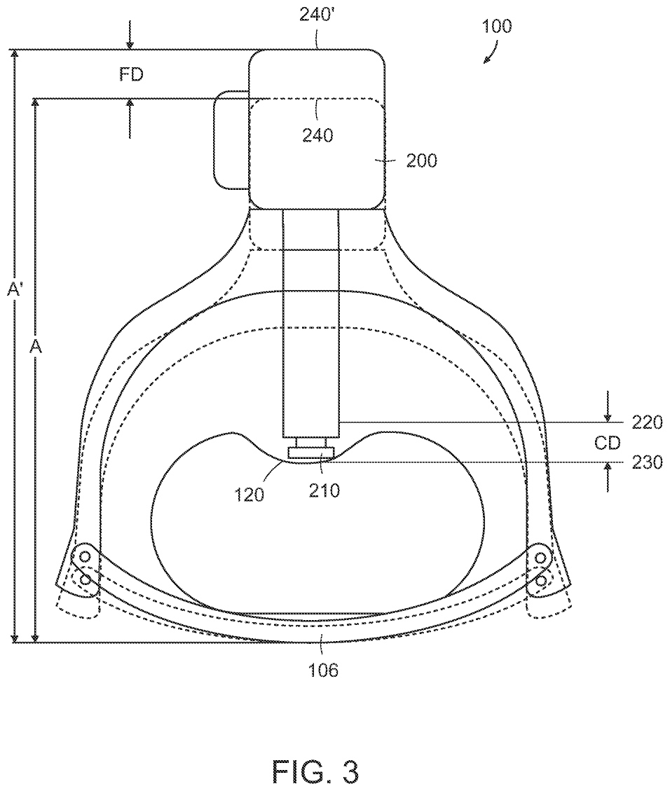

Referring to FIG. 3, in operation of the AMCPR 100 (i.e., providing CRP compressions) the movement from the starting position 220 to the extended position 230, the compression portion of a compressive stroke 302 (See FIG. 5), the patient interface 210 will be pushed into the patient's chest 120 by the ram 208. As shown in the figure, due to the force being exerted on the patient's chest by the patient interface and countered by the structure of the patient's chest, the AMCPR not being perfectly rigid will flex, at least to some degree. The flex being a flex distance “FD,” shown by the elongation of the AMCPR between the bottom surface 212 of lower portion 106 and the top surface 240 of the compression system 200.

As shown in FIGS. 4 and 5, the compression depth CD (i.e., the required movement of the patient interface 210) for a compressive stroke must be the sum of a desired therapeutic stroke depth TD and any flex distance, or flex correction, FD, where the AMCPR 100 structure has a flex which would unacceptably interfere with the AMCPR's therapeutic goal. As those skilled in the art will appreciate, any flex in the AMCPR will cause the “actual” therapeutic stroke depth delivered to a patient to be less than the “desired” therapeutic stroke depth TD. More specifically, to deliver the “desired” therapeutic stroke depth to a patient, the patient interface 210 must move from starting position 220 to the extended position 230.

Continuing, if a flex correction is not applied, the compressive stroke depth CD will only move the patient interface 210 to a third position 404 that is short of the extended position 230. As a result, the compressive depth CD will not deliver the “desired” therapeutic stroke depth TD to the patient's chest. Thus, the patient interface 210 will only move to the third position 404 leaving a deficit distance 406 in the compression stroke “actually” applied to the patient.

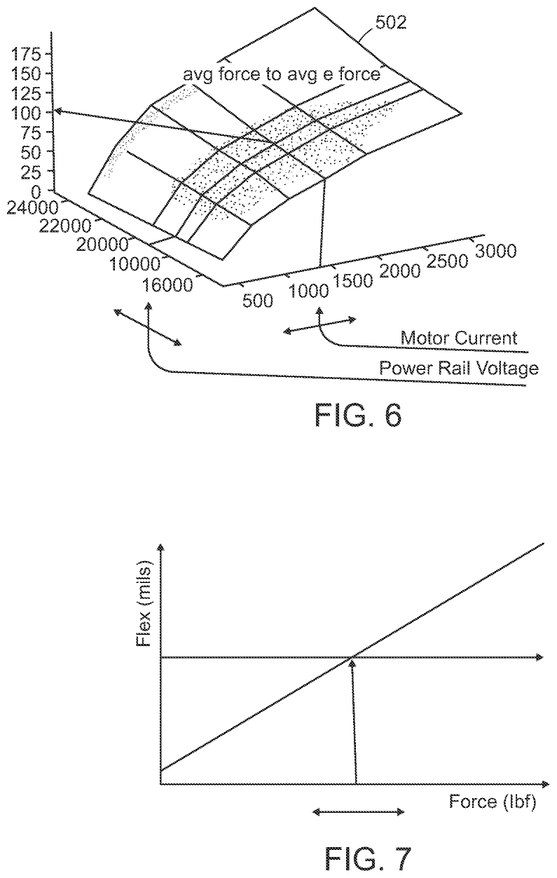

Referring to FIGS. 6 and 7, the flex correction FD to be applied to the therapeutic depth 402 is computed as follows. First, a characterization plot 300 is developed for the AMCPR 100. In this embodiment as shown in FIG. 6, the characterization plot is a bilinear plot of force obtained by combinations of applied motor current and power rail voltage at various compressive depths. This plot is obtained by experimentation, using a resistive chest simulator (e.g., spring(s)), and, thus, the obtained plot is unique to the design of a specific AMCPR design.

In some embodiments, the plot 300 is developed based on computational models of the AMCPR 100 (e.g., using MatLab or other suitable modelling packages). In other embodiments, plot 300 is developed as follows. The motor 204 has power applied at a known rail voltage. The patient interface 210 is allowed to act on the chest simulator (e.g., that is mounted on a dummy patient or otherwise) until a point of equilibrium is obtained. While holding the patient interface at the point of equilibrium, a force meter determines the force for that particular power applied and the corresponding achieved compressive depth. This procedure is repeated at various powers to develop a full mapping of the motor over the operational range. Using the data obtain, an average position at each intersection of rail voltage and amperage is taken to develop a surface 502.

Referring to FIG. 7, a 2D graph 310 relating flex to force is developed based on the mechanical characteristics of the AMCPR. It is noted that FIG. 7 shows the mechanical elasticity of the system to be linear, however this is not required as the system allows for any elasticity profile.

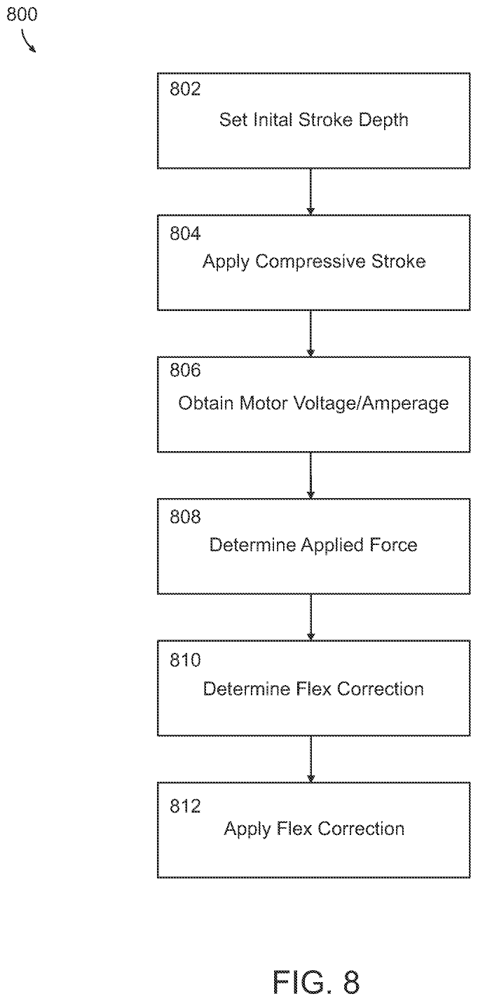

Referring to FIG. 8, in operation of an AMCPR after initial setup, which may include any initial flex correction, to deliver compressive stroke of the proper compressive stroke length 400, an AMCPR flex correction is set following a correction procedure (generally referred to by reference no. 800). It should be understood that where flex corrections are determined, flex corrections are applied to a subsequent compressive stroke (e.g., n+1) based on prior compressive strokes (e.g., n).

In a first step 802, the control system sets a compressive stroke depth (see FIG. 4). As those skilled in the art will appreciate, an initial flex correction, which could be zero, is a matter of design choice. As previously explained, in the event the flex correction is set to zero, the compressive stroke depth will equal the therapeutic stroke. It, also, should be appreciated under certain conditions, such as an initial number of compressive strokes, the initial therapeutic distance may be to a distance less than a recommended distance. Then as additional compressive strokes are delivered, the therapeutic depth may be increased to a therapeutic depth within recommended parameters. This procedure allows for flex corrections to be incrementally determined.

Then in the next step 804, a compressive stroke is delivered and the control system 202 notes the applied motor current and rail voltage at the bottom of the stroke.

In the next step 806, the motor current and rail voltage applied in the compressive stroke in the prior step 804, is converted to an applied force using a bilinear interpolation as depicted in the graph in FIG. 6.

In the next step 808, referring to FIG. 7, the applied force is used to determine an estimate of the actual flex in the AMCPR.

In step 810, the flex correction used in the compressive stroke, step 322, is compared to the new estimate of the actual flex. If they are not equal, the new estimate of the actual flex correction is used to determine a next flex correction to be used in subsequent compressive stroke(s). It should be appreciated that a next flex correction can be determined based on any number of compressive strokes, be they one stroke, or averages over multiple strokes, such as within a time period or within a battery depletion range. The correction can be similarly applied to subsequent compressive strokes, such as the next stroke, or some interval of strokes, and may vary, such as in number, time interval, or adjustments due to battery depletion.

Finally, in step 812 the next flex correction, is applied to the desired therapeutic depth 402 in a subsequent compressive stroke 400. It should be noted that how and when a flex correction in a subsequent compressive stroke is applied is a matter of design choice. The previously determined new estimate of the actual flex correction is denoted Flexₙ₋₁.

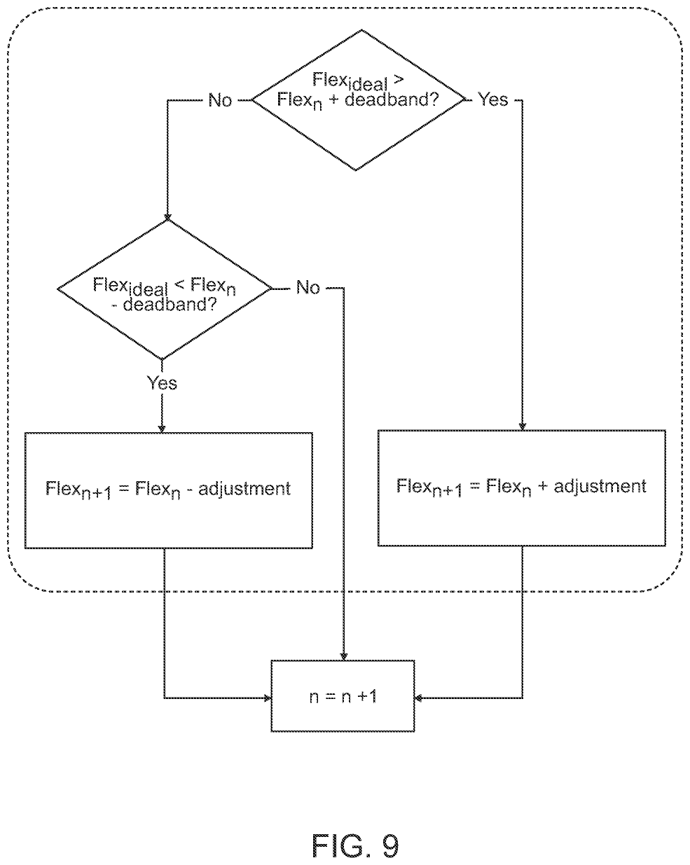

The method of determining the magnitude of the flex correction is also a matter of design choice. For example, the Flexₙ₋₁ could be used or a filtering system to moderate flex corrections could be adopted.

Where the Flexₙ₋₁ is used as the flex correction, there is a potential for wild variations in the compressive stroke 400. This is due to noise in the measurement, due to system tolerances, such as in measurements systems or mechanical interfaces. Thus, one may desire to add a filter, such as a linear filter (e.g., finite Impulse Response (FIR) or Infinite Impulse Response (IIR) filter), or non-linear low pass filter (e.g., a random walk filter) to moderate the flex correction. A random walk filter is illustrated in FIG. 9.

Continuing with FIG. 9, the force observed on a future compression, Flexₙ, is compared to Flexₙ₋₁. When Flexₙ is not equal to Flexₙ₋₁, the random walk filter first determines if the Flexₙ₋₁ is greater than Flexₙ plus a predetermined error amount, the “deadband.” The deadband is a matter of design choice, but it should be set to a value that recognizes the overall tolerance of the procedure discussed in FIG. 8. If yes, a new flex correction, Flexₙ₊₁ is set. If not and Flexₙ₋₁ is less than Flexₙ minus the deadband, the flex is adjusted. If the Flexₙ is within the deadband range, the flex is not adjusted for Flexₙ₊₁.

In cases where an adjustment is called for, the adjustment is determined as follows. While the adjustment is not necessarily determined by the delta between Flexₙ and Flexₙ₋₁, the adjustment attempts to eliminate the delta between the two in an orderly manner to ensure system stability. The magnitude of the adjustment is a matter of design choice and is based on the compressive depth 400 measurement noise in the system. Thus, it is a relatively small value. It should be appreciated that the adjustment could be a pre-determined, fixed value.

While the invention has been described above by reference to various embodiments, it will be understood that many changes and modifications can be made without departing from the scope of the invention. Thus, for example, whereas the flex correction is discussed herein as being applied during chest compression, in some embodiments it is applied instead or in addition during chest expansion—and, in such embodiments, the term “compression stroke” is to be understood to include the expansion phase of such stroke.

In view of the foregoing, what is claimed is:

1. A mechanical CPR device for providing mechanical CPR to a patient's chest, the CPR device comprising:
a support assembly having a compression system mounted therein, the support assembly defining a volume sufficient in size to accommodate a patient's torso;
the compression system including a motor coupled to a drivetrain having a patient interface, and the compression system being positioned within the support assembly to permit reciprocation of the drivetrain to deliver a compressive stroke of CPR to the patient;
a control system that is coupled to the motor to reciprocate the drivetrain so that the patient interface interacts with the patient's torso to deliver the compressive stroke of CPR to a therapeutic depth;
the control system coupled to the motor by way of at least one first sensor to obtain rotational information and by way of at least one second sensor to obtain applied amperage and applied voltage;
the control system converting (i) the obtained rotational information into a displacement of the patient interface, and (ii) the applied amperage and applied voltage obtained into a flex correction
the control system applying the flex correction to the therapeutic depth in a subsequent compressive stroke.

2. The device of claim 1, wherein the control system
determines a therapeutic depth for reciprocating the patient interface;
delivers a compressive stroke based on the therapeutic depth;
determines for the delivered compressive stroke the flex correction based on the applied amperage and applied voltage obtained; and
sets the depth of a subsequent compressive stroke to the therapeutic depth plus the determined flex correction.

3. The device of claim 1, wherein the control system applies a continuous flex correction determined based on one or more prior strokes and where that flex correction is applied to a subsequent compressive stroke.

4. The device of claim 1, wherein the control system determines the flex correction based on the rail voltage and amperage applied to a motor during one or more prior compressive strokes, such as an immediately prior stroke or such as a penultimate stroke.

5. The device of claim 1, in which the flex correction magnitude is determined using a filtering system to dampen a delta between flex corrections applied to subsequent compressions.

6. A method for flex compensation of a compressive stroke based on a previous compressive stroke in a mechanical CPR device comprising the steps of:
obtaining a mechanical CPR device having a support system with a compression system coupled to drive system mounted thereon, the compression system having a motor and patient interface, the motor capable of reciprocating a patient interface into a patient's chest to provide a CPR compressive stroke;
defining for the mechanical CPR system a first force relationship based on applied current and voltage to the motor;
categorizing the flex of the support assembly based on a second applied force to obtain a second force relationship;
determining a therapeutic depth for the reciprocating patient interface;
delivering a compressive stroke based on the therapeutic depth;
determining for the delivered compressive stroke a flex correction based on the first and second force relationship; and
setting the depth of a subsequent compressive stroke to the therapeutic depth plus the determined flex correction.

7. The AMCPR method of claim 6 that includes applying a continuous flex correction where the flex correction is determined based on one or more prior strokes and where that flex corrected applied to a subsequent compressive stroke.

8. The AMCPR method of claim 6, in which a control system determines the flex correction based on the rail voltage and amperage applied to a motor during one or more prior compressive strokes, such as an immediately prior stroke or such as the penultimate stroke.

9. The AMCPR method of claim 6 in which the flex correction magnitude is determined using a filtering system to dampen the delta between flex corrections applied to subsequent compressions.
